(19) United States
(12) Patent Application Publication
(10) Pub. No.: US 2006/0005472 A1
(43) Pub. Date: Jan. 12, 2006

(54) Rolling seal

(76) Inventor: Richard E. Miller, Atlantic Beach, FL (US)

Correspondence Address: Richard Miller, Apt. 3, 329 Aherd St., Atlantic Beach, FL, 32233, US

(21) Appl. No.: 11/224,365

(22) Filed: Sep. 12, 2005

Related U.S. Application Data
(63) Continuation-in-part of application No. 10/616,568, filed on Jul. 10, 2003.

(51) Int. Cl. E06B 7/22

(52) U.S. Cl. 49/498.1

(57) ABSTRACT

A seal having a wall or element contoured and of a predetermined shape as, for example, in the form of a right circular cylinder, an extension member and a curved sheet member joined to an extension member, with the curved sheet member along the element and curved about the element such that the curved sheet member is spaced from a surface to which the extension member is attached, such as a window sill, so that the curved sheet member is spaced from the surface and the element rolls and is compressed to seal the interface between the sash and the sill when the sash is closed against the sill with minium abrasion of the seal.

### CROSS REFERENCE TO RELATED APPLICATIONS

This is a continuation-in-part of U.S. patent application Ser. No. 10/616,568 filed Jul. 10, 2003, which claims the benefit of U.S. patent application Ser. No. 10/050,086, filed Jan. 14, 2003, which claims the benefit of U.S. patent application Ser. No. 08/910,612, filed Aug. 13, 1997, (now abandoned), which claimed the benefit of U.S. Provisional Application Ser. No. 60/028,742, filed Oct. 22, 1996.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

The invention relates to a seal to inhibit fluid leakage between two relatively moveable surfaces with the seal being attached to one of those surfaces.

The invention is a seal which attached to a first surface to seal the space between the first surface and a second surface when there is relative motion of the surfaces, such as with one surface being stationary and the other movable or both surfaces movable, the contact between the second surface and the seal causing the seal to roll and compress. Because the seal rolls between the two surfaces, there is minimum abrasion of the seal as the seal is being compressed by rolling.

There are many needs for devices, which seal the interface between a first surface and a second surface. A common example is weather stripping, which is used to keep inside air and outside air from flowing through the interfaces at windows or doors. Several problems must be over come in devising these seals. The surfaces have irregularities at the interfaces, so the seal must be compressible to fit tightly all along the interface, but the seal must not unduly impede relative motion of the surfaces and there must be minimum abrasion of the seal caused by the relative motion of the two surfaces in order to maximize the useful life of the seal.

The compression problem is addressed in prior art which shows various forms of seals which are compressed between two surfaces. In U.S. Pat. No. 445,544, Cosper shows a seal which is the lateral surface of a right cylinder which is compressed to an oval cross-section between two surfaces. It does not roll to minimize abrasion as it is compressed. Similar tubular seals with various cross-sections are shown in U.S. Pat. No. 2,451,450 to Spraragen, in U.S. Pat. No. 2,732,596 and German Patent No. 900,006 boh to Kellner, in U.S. Pat. No. 3,518,793 to Hirtle, in U.S. Pat. No. 4,658,548 to Gerritsen. These seals do not roll during compression in order to minimize abrasion of the seal by motion of the surfaces.

Thus there is a need for a seal that is compressed between two surfaces by rolling so that the rolling minimizes abrasion of the seal by the moving structure.

Objects of this invention include providing a seal which can be affixed to a first surface and which will be compressed to seal the interface with a second surface. A further object is to provide a seal structure which allows the seal wall or element to roll when there is relative motion of the first surface with respect to the second surface in order to minimize abrasion of the seal by the motion, which is accomplished by providing a coiled sheet member attached to the seal element. A further object is to control the resistance to roll by varying the material of composition, its thickness or its configuration. Other objects will be comprehended in the drawings and detailed description, which will make additional objects obvious herein to persons skilled in the arts.

### SUMMARY OF THE INVENTION

The invention is in general a longitudinally extending seal having a resiliently compressible wall or element contoured into a predetermined shape, for example, a generally right circular cylinder being tubular or solid in cross-section, the element having an arcuate or coiled sheet member having an edge attached longitudinally along the element, with the coiled sheet member being coiled along an arc of the element and joined by another edge to an extension member which is affixed to a first surface, the coiled sheet member allowing the element to roll as it is compressed against a second surface spaced from the first surface in either of two opposing directions. In the passive state, with no pressure applied against the element in either direction, the coiled sheet member remains spaced from the first surface. With pressure applied against the element causing the element to roll in a first direction away from the coiled sheet member, the coiled sheet member adapts to a more planar configuration. When pressure is applied against the element in a second opposite direction causing the element to roll in the second direction toward the coiled sheet member, the coiled sheet member adapts to a more tightly coiled configuration. The degree of resistance or ease of roll is governed by the choice of materials and thickness of the coiled sheet member, such that a thinner or more pliant material will roll more easily than a thicker or more pliant material, as well as by the configuration of the surface of the extension member adjacent the element.

### BRIEF DESCRIPTION OF THE DRAWINGS

The novel features which are believed to be characteristic of this invention are set forth with particularity in the appended claims. The invention itself, however, both as to its organization and method of operation, together with further objects and advantages thereof, may best be understood by reference to the following description taken in connection with the accompanying drawings, in which:

FIG. 1 shows an embodiment of the seal, where the wall or element is tubular;

FIG. 2 shows the seal attached to a windowsill with the bottom rail of a window sash just encountering the seal;

FIG. 3 shows the seal being unrolled and compressed;

FIG. 4 shows the rolling seal attached to a vertical part of a window frame with a vertical part of a window sash rolling and compressing the seal;

FIG. 5 is a cross-sectional view of an alternative embodiment of a seal, where the resilient, compressible wall or element has a solid cross-section;

FIG. 6 is an end view of another alternative embodiment of the invention, where the seal wall or element is configured as an O-ring;

FIG. 7 is a cross-sectional view taken along line VII-VII of FIG. 6, showing the seal in relation to a moving shaft;

FIG. 8 is a cross-sectional view of an alternative embodiment of a seal, where the extension member is wedge-shaped;

FIG. 9 is a cross-sectional view of an alternative embodiment of a seal, where the extension member is stepped;

FIG. 10 is a cross-sectional view of an alternative embodiment of a seal, where the arcuate sheet member extends approximately 180 degrees from the attachment edge;

FIG. 11 is a cross-sectional view of an alternative embodiment of a seal, where the seal wall or element is general elliptical in shape;

FIG. 12 is a side view of an alternative embodiment of a seal, where the seal wall or element is a polygon in the form of a square;

FIG. 13 is a side view of an alternative embodiment of a seal, where the seal wall or element is a polygon in the form of a rectangle;

FIG. 14 is a side view of an alternative embodiment of a seal, where the seal wall or element is a polygon in the form of a hexagon;

FIG. 15 is a side view of an alternative embodiment of a seal, where the seal wall or element is a polygon in the form of a triangle;

FIG. 16 is a side view of an alternative embodiment of a seal, where the seal wall or element is arcuate and includes a free edge;

FIG. 17 is a side view of an alternative embodiment of a seal where the seal wall or element is arcuate having relief groves and including a free edge;

FIG. 18 is a side view of an alternative embodiment of a seal, where the seal wall or element is straight with one relief grove;

FIG. 19 is a side view of an alternative embodiment of a seal, where the seal wall or element in the passive state is straight with many relief groves; and

FIG. 20 is a side view of the seal wall or element of FIG. 19 where the seal wall in the active state is curved.

### DETAILED DESCRIPTION OF THE INVENTION

Many illustrated embodiments are disclosed herein and reference characters generally referring to similar components will have the same base character, for example, 10, 10A, 10B, etc.

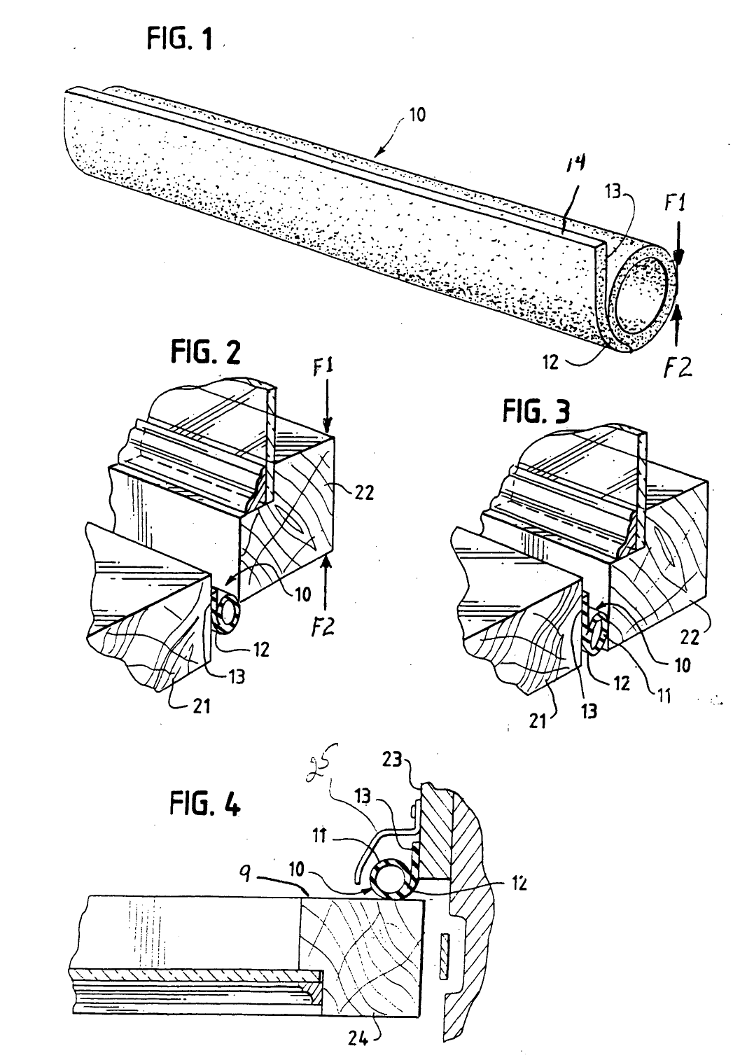

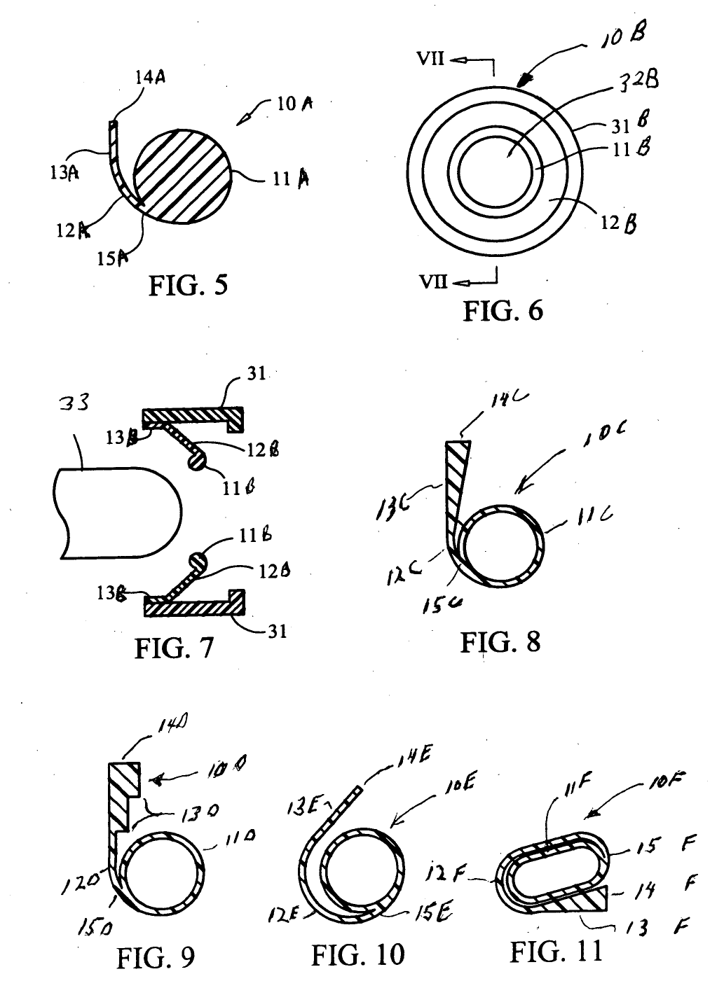

An embodiment of a rolling seal 10 is shown in FIG. 1 The rolling seal 10 has a wall 11, which is generally in the form of a right circular cylinder, which may be tubular as shown in FIGS. 1 through 4 or solid as in FIG. 5. An arcuate sheet member 12 having an attachment edge 15 is joined longitudinally to the element 11, either continuously or intermittently, and is curled along an arc of the wall 11 in spatial relation. An extension member 13 is joined to the arcuate sheet member 12, which is preferably generally planar but may also have other varying configurations, which extends outward from the arcuate sheet member and terminates in a free edge 14. The extension member 13 is spaced away from attachment edge 15 and extension member 13 is adapted to be attached to a first surface by use of adhesives, mechanical fasteners or other suitable means to secure the rolling seal 10 in proper position during use.

The rolling seal 10 is formed of a resilient, compressible material, preferably comprising a rubber, polymer material or polymer foam, such as, for example, silicone, vinyl or the like. Preferably, the rolling seal 10 is formed as an extrusion such that the seal 10 is a unitary piece, although it would be possible to construct the rolling seal 10 from separate components.

In the passive state, where no pressure is directed against the wall or element 11, the arcuate sheet 12 and the extension member 13 reside in a spaced relation to the wall 11, such that the only contact between the wall 11 and the coiled arcuate sheet 12 occurs along the attachment edge 15. With the extension member 13 affixed to a first surface, the coiled sheet 12 and wall 11 will be disposed spacedly away from such first surface.

In FIGS. 2 and 3, the extension member 13 only is shown attached to a first surface, which in this case is a windowsill 21, and the effects of pressure being applied against the wall 11 by sash 22 in a first direction F1 is shown. Here a second surface, which in this case is a bottom rail of a window sash 22, is just encountering the wall or element 11, with the sash 22 shown being moved in a downward direction F1, toward the rolling seal 10. In FIG. 3 the sash 22 is disposed opposite the sill 21, i.e., the window is shown in the closed state, and the contact between the sash 22 and the element 11 has unrolled or flattened the curled sheet member 12 in the direction away from the attached extension member 13, and has simultaneously compressed the element 11 in the interface between the sill 21 and the sash 22, thereby sealing the interface between the opposed surfaces of the sill 21 and sash 22. Because of the curl of arcuate sheet member 12, the element 11 is able to roll or rotate to reduce the abrasive friction effects from contact with the sash 22.

In FIG. 4, the extension member 13 is shown attached to a first surface, which in this case is a vertical portion of a window frame 23 having a seal protective cover 25. Here a second surface 9, which in this case is the upper portion of a window sash 24, contacts the seal 10 as the sash 24 is lowered to close the window. This contact with the sash 24 rolls the curled sheet member 12 toward the attached extension member 13 and compresses the element 11 to seal the interface between the frame 23 and the sash 24. As above, the curled arcuate sheet member 12 allows the wall 11 to roll or rotate to reduce the friction effects.

The amount of resistance to roll or rotation of wall or element 11 is controlled by the material chosen for the curled sheet member 12, with a stiffer material providing more compression than a more pliant material, or by the thickness of the curled sheet member 12. A thick curled sheet member 12 will provide a more stable passive position for the seal 10, but will allow for increased pressure being applied to sill 21 and sash 22 by seal wall 11. With a thinner curled sheet member 12 the resistance of compression of seal wall 11 may also be controlled by varying the configuration of the extension member 13C or 13D, such as shown in FIGS. 8 and 9. In FIG. 8 the extension member 13C is formed in a wedge shape, such that the element 11C encounters a thicker portion of the extension member 13C as the element 11C is rolled in direction F2 the extension member 12C, thereby increasing the compression on the element 11C. In FIG. 9 the extension member 13D is formed in a stepped configuration, such as the element 11D is rolled in direction F2 the resistance to roll increases incrementally when one of the 13H steps are encountered.

In FIGS. 2 and 3, the sill 21 and the sash 22 are shown to be generally parallel and both generally planar, and in FIG. 4, the jam 23 and the upper sash 24 are shown to be generally parallel and generally perpendicular. Other configurations would be substantially equivalent. The surfaces need not be parallel and they need not be planar. For example, the sill can be angled away from the vertical plane of the sash and could be provided with a lip extending toward the sash in order to minimize the space between the sill and sash when the window is closed.

In one embodiment, the curled sheet member 12 is wound around wall 11 over an arc covering at approximately 45 degrees from the attachment edge 15 on wall or element 11. As shown in FIG. 10; the arc of the curled sheet member 12E may even comprise up to more than 180 degrees from the attachment edge 15E.

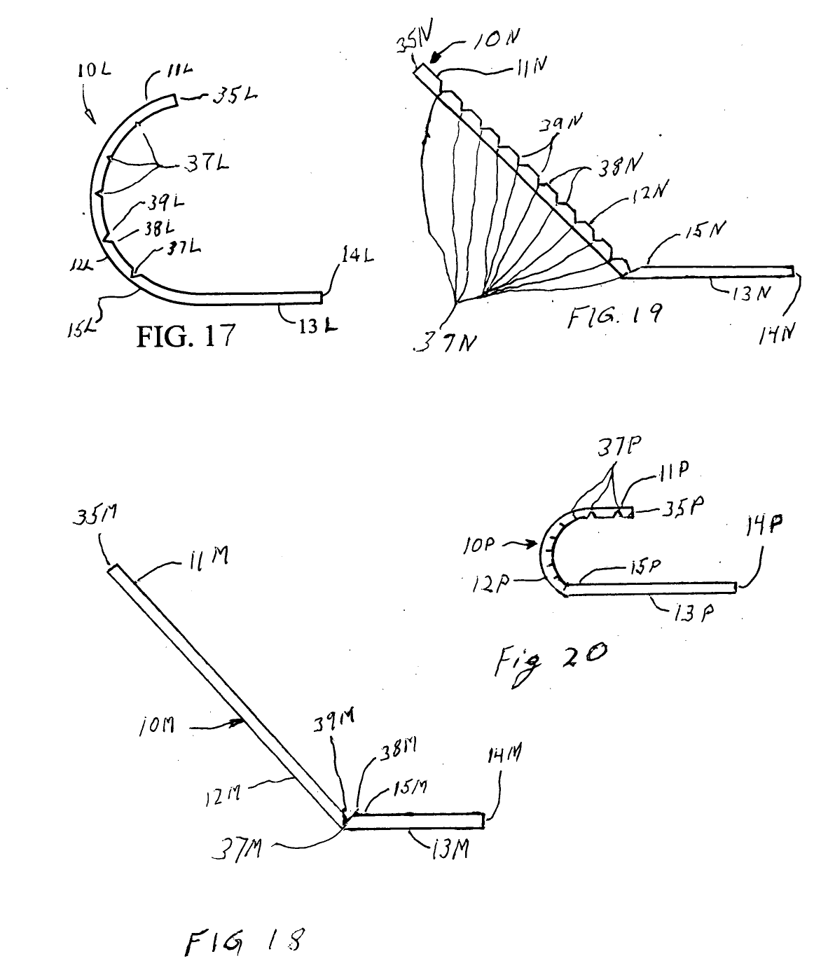

Other equivalent forms for the wall or element 11, the curled sheet member 12, and the extension member 13 need only be provided at spaced intervals along the wall or element 11, the cylinder ends could be joined to form a ring seal as illustrated in FIGS. 6 and 7 the wall or element 11 could bound a cylinder which is not a circular cylinder, as illustrated in FIGS. 11-15. Many variations are possible so long as the seal can be attached to a first surface, unrolled, and rolled, and compressed in the interface with a second surface by relative motion between the first surface and the second surface. An alternative embodiment is shown in FIG. 11, where the wall or element 11F is elliptical in configuration. FIG. 16, where the wall or element 11K is itself coiled with a free edge 35 disposed spacedly from the coiled sheet member 12K.

Although the rolling seal 10 has been described herein in relation to window closures, it is to be understood that rolling seal 10 can be utilized in a multitude of situations where a compressible seal is desired between two relatively movable members or surfaces, such as for example, a doorway.

A further alternative embodiment of the seal 10B in the nature of an o-ring is shown in FIGS. 6 and 7. In this embodiment, the wall 11B is a circular or annular member forming a circular aperture 32B, and the curled arcuate sheet member 12B extends outwardly from the aperture 32B, preferably over the full 360 degrees extent of the aperture 32B. The extension member 13B is attached to a first surface, here shown as a housing 31. A second surface, here shown as a shaft 33, passes through the aperture 11B and contacts the seal wall 11B. In a manner similar to that set forth above, the curled sheet member 12B allows the element 11B to rotate or roll in response to movement of shaft 33 relative to housing 31, thereby reducing the abrasive friction effects. Furthermore, because the sheet member 12B is formed of a resilient material, the central axis of the aperture 32 can be disposed in any direction perpendicular to the axis, i.e., can be shifted off-center, without causing the element 11B to lose contact with the shaft 33.

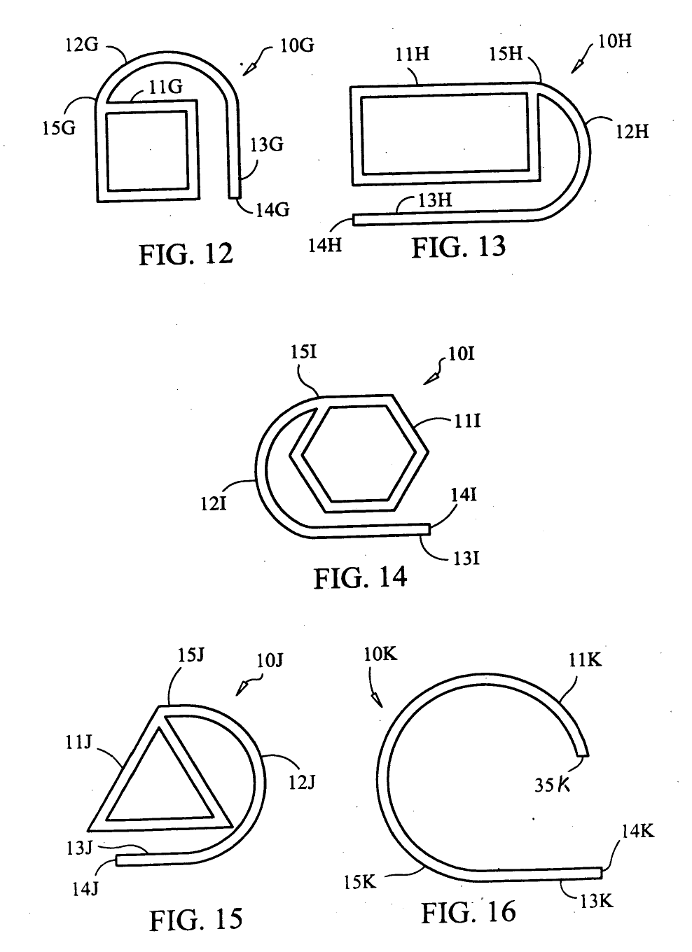

As illustrated in FIGS. 11-15, the wall or element 11F-J may be of any contour that will permit the rolling out or rolling up of the curled arcuate sheet member 12F-J. Also, a more compressed state of the seal 10F-J is achievable with less rolling motion than the cylindrical or round embodiments of the rolling seal 10, and 10C-10E. Pointed corners of element 11G-J achieve greater pressure per square inch since there is less contact surface when a corner is being compressed than when a flat side or the respective seal is being compressed. The polygons, illustrated in FIGS. 12-15, are understood not to be limiting but other cross-sectional shapes such as a pentagon, octagon, etc., are envisioned as well as trapezoids, parallelograms, etc. also, the tubular form of wall or element 11F-11J may be solid, like 11A in FIG. 5, and all corners may be rounded rather than being sharp, as would be understood in the arts.

The seal 10K of FIG. 16 has an arcuate element 11K with a free edge 35 that span approximately 45 to 180 degree so that it would roll much more easily and compress more readily. Such an element would be advantageous for windows and doors where only a minimal pressure is required to achieve an adequate seal with minimum adverse effects on normal opening and closing of such windows and doors. Also, if these doors and windows are subject to the environment, the wind will enhance the sealing ability, i.e., the harder the wind blows into the arcuate element 11K, the greater the sealing pressure of the seal that will be achieved.

FIG. 17 demonstrates the seal element 11L similar to that of FIG. 16, with a free edge but having groves 37 formed into the inner wall of element 11L. The groves make it possible to determine where the element wall 11L will bend easily and how far the element wall 11L is allowed to bend easily. When the edges 38 and 39 of grove 37 make contact the effort required for bending increase. The amount of easy bending of element wall 11L is determined by the space between the edges 38 and 39 of grove 37. Another controlling factor would be the number and depth of groves 37 in element wall 11L. FIG. 18 shows still another seal embodiment where the element 11M is straight having only one grove 37. FIG. 19 demonstrates a straight version of seal element 11M in the passive state with many groves 37. FIG. 20 shows the seal element 11M in an active condition where the seal element is compressed and forming a curved element wall 11M. The straight wall 11M when rolled between two surfaces, the free edge portion of straight wall 11M becomes curved, as shown in FIG. 20. The groves may be round, square, triangular, etc.

Other equivalent forms for the wall or element 11 the curled sheet member 12, and the extension member 13 attaching the rolling seal 10 to a surface will be obvious hereafter to persons skilled in the art. Therefore, this invention is not limited to the particular examples shown and described here, but instead the scope and definition of the invention is to be set fourth in the following claims.

I claim:

1. A rolling seal useable with a closure having first and second surfaces moveable relative to each other, the rolling seal comprising:
a wall generally in the form of a right circular cylinder, said wall being resiliently compressible; and
a resilient coiled sheet member having an attachment portion attached to said wall, said sheet member being at least partially coiled about said wall.

2. The rolling seal according to claim 1, further comprising an extension member joined to another attachment portion of said sheet member, said extension member being adapted to be joined to a first surface of a closure.

3. The rolling seal according to claim 1, wherein said rolling seal wall is a contoured element having a predetermined shape, said contoured element being resiliently compressible.

4. The rolling seal according to claim 2, wherein said extension member is generally planar.

5. The rolling seal according to claim 2, wherein said extension member is wedge-shaped.

6. The rolling seal according to claim 2, wherein said extension member is stepped.

7. The rolling seal according to claim 3 wherein said wall is cylindrical.

8. The rolling seal according to claim 3, wherein said wall is solid.

9. The rolling seal according to claim 1, wherein said sheet member is coiled around said wall over an arc covering approximately 45 degrees of said wall.

10. The seal according to claim 3, wherein said wall is annular.

11. The seal according to claim 3, wherein said wall includes at least one corner.

12. The seal according to claim 3, wherein said wall in cross-section is a polygon.

13. The seal according to claim 3, wherein said wall in cross-section is generally elliptical.

14. The seal according to claim 3, wherein said wall in cross-section is a curved and includes a free edge.

15. The seal according to claim 14, wherein said wall of said element is generally curved having cut away portions or groves in said wall allowing said wall to bend easily at a predetermined portion of said curved wall.

16. The seal according to claim 14, wherein said cut away portions or groves are “V” shaped.

17. The seal according to claim 14, wherein said seal wall is straight.

18. The seal according to claim 17, wherein said wall may have one “V” shaped grove or many.

19. The seal according to claim 17,wherein said seal wall in a compressed state, form an arc.
